(19) United States
(12) Patent Application Publication
(10) Pub. No.: US 2002/0055933 A1
(43) Pub. Date: May 9, 2002

(54) Method and system for dynamically maintaining internet associations

(76) Inventors: Kirk Feathers, Ballston Spa, NY (US); Gregory Kerber, Cohoes, NY (US)

Correspondence Address: BUCHANAN INGERSOLL, P.C., 301 GRANT STREET, 20TH FLOOR, PITTSBURGH, PA, 15219

(21) Appl. No.: 09/682,791

(22) Filed: Oct. 19, 2001

Related U.S. Application Data
(60) Provisional application No. 60/241,649, filed on Oct. 19, 2000.

(51) Int. Cl. G06F 7/00

(52) U.S. Cl. 707/104.1

(57) ABSTRACT

A method is disclosed wherein a source referring users to an on-line retailer is uniquely identified to the on-line retailer every time the user visits the on-line retailer's web site. This is accomplished by automatically appending a unique identification code identifying the referring source to the user's request to visit the site, regardless where in the user is logically located on the Internet when the request occurs

### RELATED APPLICATIONS

### REFERENCED-APPLICATIONS

The application claims the benefit of U.S. provisional application Ser. No. 60/241,649, filed Oct. 19, 2000.

### FIELD OF THE INVENTION

The present invention relates to Internet web site associations. More specifically, this invention relates to dynamically maintaining web site associations.

### BACKGROUND OF INVENTION

Increased popularity of the Internet has made possible new methods of marketing goods and services to consumers or users. A common method used for marketing by online merchants is to reward associated, or affiliated, web site operators for directing users to a merchant's web site and encouraging a purchase. The associated or affiliated web site operator may further reward the user when the user purchases items from the merchant site. Methods of associating web sites with affiliated web sites are well known in the art. Using these known methods, a merchant can pay advertisers, or associated web site operators in the form of commissions or revenue sharing. As it requires the merchant to pay for advertising that results in directed traffic, sales or purchases, commissions and revenue sharing have become a preferred practice among web site operators. Hence, if an advertiser, or affiliate, does not result in directed traffic or a sale or a purchase then the merchant need not compensate the advertiser or affiliate web site operator.

However, current communication protocols restrict an affiliate operator's ability to consistently identify themselves as the entity responsible for directing traffic to a merchant's web site (i.e., the referring source). Referrals are recognized when a user travels directly from the referring source's web site to a merchant's web site and makes a purchase within that web site session. If the user travels to a second merchant's web site and then returns to the first merchant's web site, the referral source's identification is lost. As the referral source's identification is lost, the advertiser or affiliate operator is denied a credit for directing the user to the merchant. The advertiser or affiliate operator thus experiences a significant loss in potential revenue from a sale or purchase that a user may make at the merchant's web site. Similarly, if a user is a member of a group, organization or web site affiliation, which provides for a group discount or reimbursement when purchasing items on-line, the user group, organization or web site affiliation is also lost as the user traverses among different web sites. Hence, there is a need to dynamically allocate a referring source's identification to a user's web site request to prevent the user's affiliation or the referring source's identification from being lost as the user traverses among web sites.

### SUMMARY OF INVENTION

A method of maintaining the identity of a referring source to a plurality of on-line retailers is presented. The method examines a Internet address that is issued by a user for the presence of an identification code for the referring source. When the identification code is not present in said Internet address, the method selects an identification code from a plurality of identification codes which are operative as a referring source registration with a corresponding one of said plurality of retailers. The method then amends the Internet address to incorporate the selected identification code and causes the amended Internet address to be issued with the included identification code.

### BRIEF DESCRIPTION OF DRAWINGS

FIG. 1 illustrates an exemplary Internet network configuration;

FIG. 2 illustrates an exemplary Internet web transaction in accordance with a first embodiment of the invention;

FIG. 3 illustrates a second exemplary Internet web transaction in accordance with a first embodiment of the invention.

FIG. 4 depicts an exemplary flow chart of processing in accordance with a first embodiment of the invention;

FIG. 5 illustrates a third exemplary Internet web transaction in accordance with a first embodiment of the invention; and

FIG. 6 illustrates an exemplary Internet web transaction in accordance with a second embodiment of the invention.

It is to be understood that these drawings are solely for purposes of illustrating the concepts of the invention and are not intended as a definition of the limits of the invention. It will be appreciated that the same reference numerals, possibly supplemented with reference characters where appropriate, have been used throughout to identify corresponding parts.

### DETAILED DESCRIPTION OF THE INVENTION

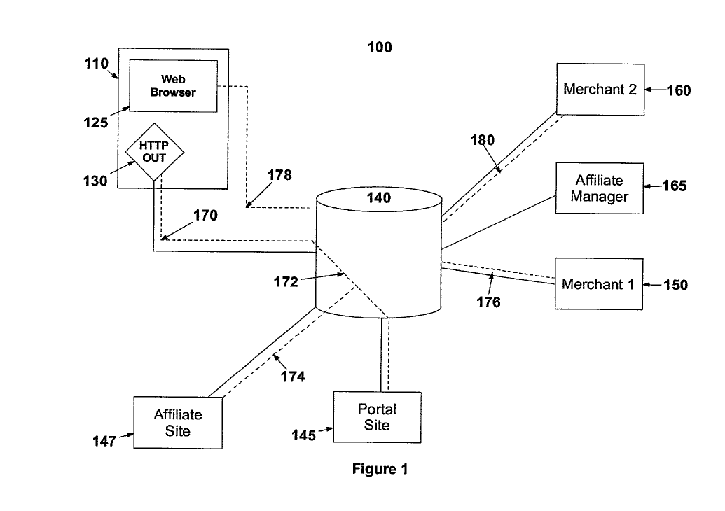

FIG. 1 illustrates an exemplary Internet network 100 wherein user computing system 110 communicates, via communication network 140, with a plurality of web sites, as represented by Portal web site 145, Affiliate web site 147, Merchant 1 web site 150, Merchant 2 web site 160 and Affiliate Manager web site 165. In this illustrative network, Merchant 1 site 150 and Merchant 2 site 160 are representative of on-line retailing web sites that contain information items, e.g., goods, services, etc., that a user desires to view, compare and, subsequently, purchase. Affiliate site 147 is representative of a web site that has an affiliate or associate relationship with Merchant 1 site 150 or Merchant 2 site 160. Affiliate site 147 may have a relation wherein a merchant site may pay a commission to the operator of Affiliate site 147 for each user that Affiliate site 147 directs to the merchant site. Affiliate Manager site 165 is representative of a site that Manager 2 site 160, for example, uses to manage, track and record users and affiliated web sites that access Manager 2 site 160. Portal site 145 is representative of a web site that may be affiliated or associated with on-line retailers, such as illustrated Merchant 1 site 150 and Merchant 2 site 160, and further may be representative of a group, organization, club, etc. that includes member users. Merchant 1 site 150 may sell compact disks (CDs), for example, while Merchant 2 site 160 may sell books. Affiliate site 147 may be associated with both Merchant 1 site 150 and Merchant 2 site 160 by including on its own web site a reference to Merchant 1 site 150 and Merchant 2 site 160.

Included on user computing system 110 is web browser 125, e.g., Internet Explorer or Netscape Explorer, which allows a user to enter textual or graphical data that is subsequently transmitted over network 140, through module “HTTP Out” 130. Such transmissions are typically requests, as represented by request 170, for access to a known web site. Web browser 125 further enables a user to view responses to a request. Link 178 is illustrative of a response from a merchant, merchant affiliate or portal site on network 140. A user accesses information items contained on Merchant 1 site 150, for example, by entering an appropriate Universal Resource Locator (URL) into web browser 125 and having this URL address transmitted over network 140. A response from Merchant 1 site 150, as represented by communication links 176 and 178, respectively, is then returned to the user computer system 110 and displayed, using browser 125.

A user may also be directed from a third party web site located, for example, on Portal site 145 or Affiliate site 147, to Merchant 1 web site 150, by a link to the latter's web site placed on the web site page of the former. In this case, a user first accesses, for example, affiliate site 147 and is then referred to the merchant site through a prearranged hyperlink that is agreed to by the operators of the respective merchant and affiliate web sites. When there is a cooperative agreement between the operators, for example, of Affiliate site 147 and Merchant 1 site 150, the operator of Affiliate site 147 may receive a commission, or share in any revenue generated, for referring a user to the respective merchant's web site. Methods for providing referrals and collecting payments are well known in the art. For example, U.S. Pat. No. 6,029, 141 entitled, Internet-Based Customer Referral System, dated, Feb. 22, 2000, to Bezos, et al., discloses one method of providing and recording a referral source. In this case, the Affiliate web site 147 is identified to the merchant site by the incorporation of a pre-arranged affiliate site identification code in the hypertext linkage displayed to the user that is used to transfer the user to the merchant site. That is, the affiliate's identification is pre-stored in the hypertext link address displayed on an affiliate's web site page. Additionally, a second identifier uniquely identifying the particular user may be incorporated in the request.

As would be appreciated, as a user navigates around the Internet, this static, pre-stored, affiliate identification is easily lost. For example, a user may first access an affiliate web site and may then be transferred to a merchant site where a session is initiated. The user may then manually enter a new URL to access a second merchant, thus ending the first merchant session. The user may then return to the first merchant site, without returning to Affiliate site 147. In this case, the identification with Affiliate site 147 as the referring source is lost, as the affiliate identification is no longer attached to the requesting address. Hence, Affiliate site 147 is not credited with directing the user to merchant 1 site 150. Similarly, if the user is a member of a group, as represented by portal site 145, web site access through a manually entered URL or through an unaffiliated site (not shown) does not identify the user as a member of club, group, organization, etc., that has an arrangement with Portal site 145. Furthermore, Portal site 145 is not credited with one of its members accessing and purchasing from a participating retailer or merchant.

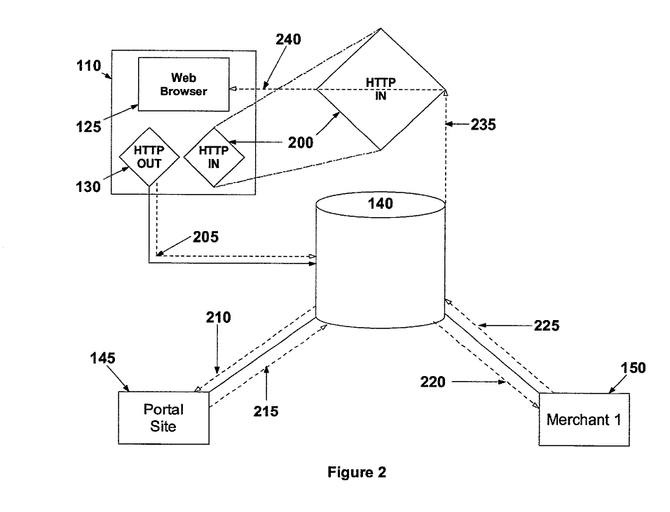

FIG. 2 illustrates an exemplary Internet exchange in accordance with one embodiment of the invention. In this exemplary exchange, a user is a member of a group, as represented by Portal site 145. Portal site 145 is further associated or affiliated with Merchant 1 site 150. As member of a group, module 200, entitled “HTTP In,” is resident on user computer system 110. Module HTTP In 200 is representative of a browser plug-in that is downloaded and installed on the computer system of user 110. Downloading and installation of software on a user's computer system is well known in the art and need not be discussed in detail herein. In an alternative embodiment, HTTP In 200 can be provided on a physical media, such as CD-ROM or floppy disk and can be installed on a computer system 110 using known installation methods. Furtherstill, HTTP In 200 can be included in a proprietary software package which, when installed on computing system 110 identifies the user to access the Internet. The presence of module HTTP In 200 on system 110 identifies the user as a member of a select group of users. That is, HTTP In 200 is available to users who, for example, are registered with portal site 145.

After installation, module HTTP In 200 resides in the communication path between browser 125 of user system 110 and the network interface connection (NIC) to the Internet. HTTP In 200 monitors and evaluates the messages received by computing system 110 and verifies that the appropriate membership information is included within the received data. In accordance with the principles of the invention, each time information passes through module HTTP In 200, the information is evaluated to determine whether the proper identification is included in the message.

In this example, the user requests access to Portal system 145 using its URL address, as represented by communication links 205 and 210, respectively. The user requests access to Portal system 145 because the user is a member of a group represented by Portal system 145 and receives a benefit from such membership. In viewing the web site of Portal system 145, the user is provided an opportunity to access at least one merchant web site 150 that Portal site 145 is associated with. If, for example, the user desires to purchase goods or services at Merchant 1 site 150, the user may use a hyperlink contained on Portal site 145 to access Merchant 1 site 150. The request for access to Merchant 1 site 150 is represented by communication links 215 and 220. As previously discussed, the identification of Portal site 145 may be included in the hyperlink address, based on the designed merchant web site the user desires to visit.

Merchant 1 site 150, after receiving the user's request then responds, as represented by communication links 225 and 235, to the user request. The response is intercepted by module HTTP In 200, as illustrated in the enlarged drawing of module HTTP In 200, and evaluated to determine whether the proper association identification is present. In this illustrative example, as the user has accessed merchant 1 site 150 through Portal site 145, the proper identification of Portal site 145 is included in the response of Merchant 1 site 150. Hence, the response message is passed to web browser 125, as presented by communication link 240, for display to the user.

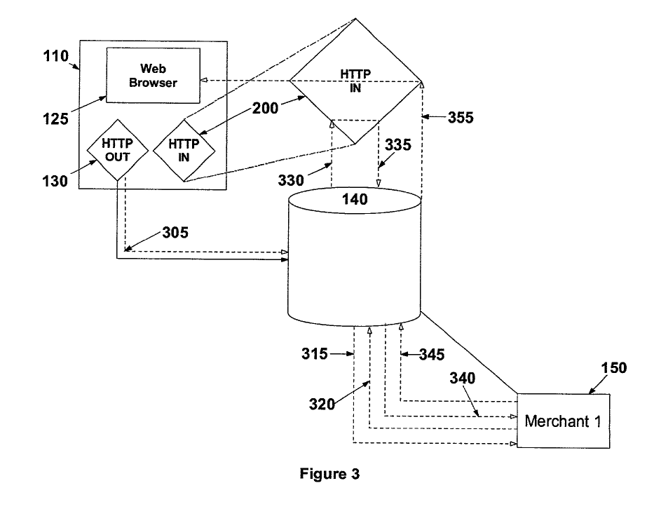

FIG. 3 illustrates a second exemplary Internet exchange in accordance with one embodiment of the invention. In this illustrative example, user requests access to Merchant 1 web site 150 directly, as represented by communication links 305 and 315, respectively. In this case, Portal site 145 is bypassed. Hence, neither the identification of Portal site 145 nor the user as a member of Portal site 145 is included in the URL address. Merchant 1 site 150, in response, opens a new session and responds to the user's request, as represented by communication links 320 and 330 respectively. Module HTTP In 200, upon receiving the response message of Merchant 1 site 150, evaluates the response message to determine whether the response message includes identification parameters that identify Portal site 145 or as a member of Portal site 145. In determining that the proper identification is not present, module HTTP In 200 dynamically amends the user's request to include the proper identification code in the user's request message and causes the amended user request to be re-issued, as represented by communication links 335 and 340. Additionally, a second identifier uniquely identifying the particular user may be incorporated in the re-issued request. In this case, Merchant 1 site 150, upon receiving the amended request, records the now identified association, opens a new session, and issues a response, as represented by communication links 345 and 355. Module HTTP In 200, upon receiving the response for the amended request, evaluates this response to determine whether the proper identification is included in the response. After determining that the proper identification is included, the response message is forwarded to web browser 125 for viewing by the user.

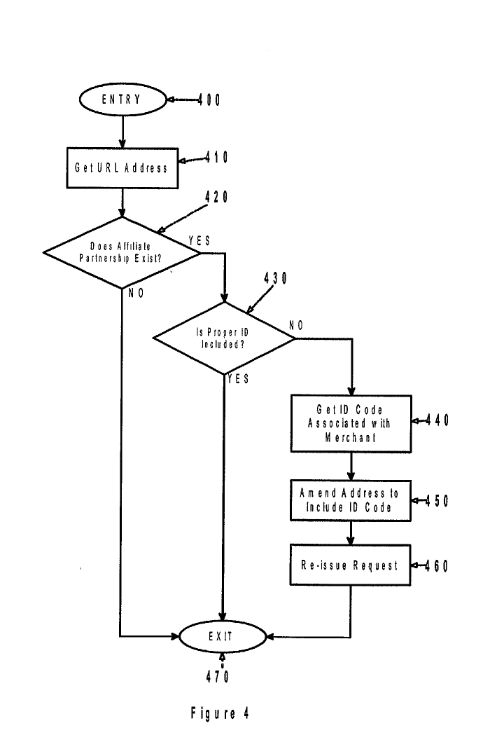

FIG. 4 illustrates an exemplary process flowchart of module HTTP In 200 in evaluating response messages. Upon entry at block 400, module HTTP In 200 extracts the requesting URL address from response message, at block 410. A determination is then made, at block 420, as to whether an affiliate or associate relation between the responding merchant and a designated referring web site or agent exists. If the answer is in the negative, then the program is exited and the response message is forwarded for viewing by the user. if the answer, however, is in the affirmative, then a determination is made, at block 430, as to whether the requesting address includes proper identification of a designated referring web site or agent. If the determination is in the affirmative, then the program is exited and the response message is forwarded for viewing by the user.

If, however, the determination is in the negative, then the identification code of the referring web site or agent associated with the responding merchant is obtained, at block 440. The identification code is then dynamically inserted in the user-requested address, at block 450. As would be appreciated, a referring web site or agent may have a different identification for each different associated merchant or retailer. Furtherstill, the placement of the identification may be different for each different associated merchant or retailer. At block 460, the amended request message, containing the identification code, is then transmitted over the communication link to the specified merchant. The program then exits at 470 to await the response from the merchant.

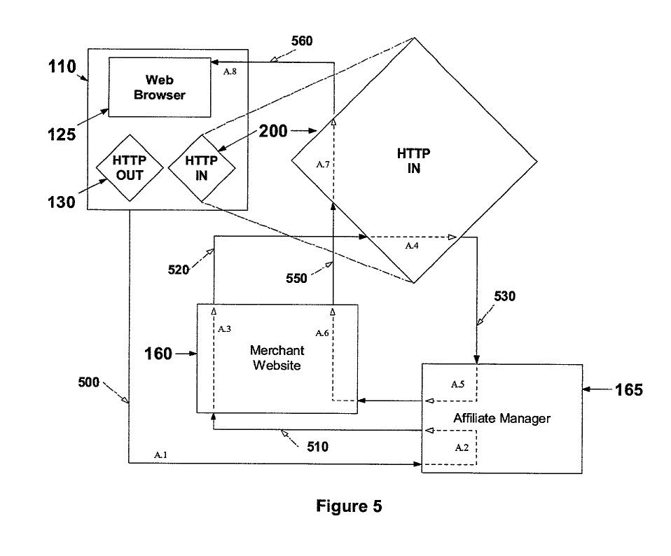

FIG. 5 illustrates still another exemplary Internet transaction in accordance with one embodiment of the invention. In this illustrated example, a user makes request 500 to access a merchant web site page through browser 125. As previously discussed, request 500 is submitted over the network 140 by clicking on a hyperlink, or alternatively, selecting a link from a list of hyperlink addresses. The list of hyperlink addresses may be a list created by the user or may be a list accessible by the user through a portal site, for example. The list of merchant hyperlink addresses may be represented as graphical images of a respective merchant's name or distinguishing icons or marks. Furthermore, the merchant list can, for example, be displayed such that each displayed merchant has similar items for sale.

Browser 125 outputs the selected merchant's Internet address via module “HTTP Out” 130. In this illustrative example, merchant web site 160 utilizes a third party affiliate manager web site 165 that manages and records web site referrals. Affiliate manager 165 contains information necessary to identify the referring source and the desired merchant.

Affiliate manager web site 165 next sends to the user information concerning the desired merchant web site 160, as represented by communication link 510. Merchant web site 160 acknowledges request 510, opens a session, with identification, and sends connection information back to user, as represented by link 520.

Module HTTP In 200, upon receiving the response message as represented by communication link 520, evaluates the received connection information to determine whether the appropriate identification is included in the response. In this case, as the appropriate identification is not included in the response, module HTTP In 200 references an array of affiliate identification codes or re-direct addresses which are used to direct or re-direct the request so as to identify the referring source. As would be appreciated, the array of affiliate identification codes or re-direct addresses may be downloaded onto the computer system 110 when browser 125 is initially accessed. Alternatively, the array of affiliate identification codes or redirect addresses may include a version number, which is used to determine when an updated version of the affiliate array is to be downloaded. In such a case, an updated version is downloaded onto computer system 110 when it is determined that the version of the affiliate array on a server system includes information that is more recent than that version on system 110.

After referencing the affiliate array to extract the required information and amend the request address appropriately, Module HTTP In 200 then causes the amended user request to be re-issued to Affiliate manager web site 165 with the information needed to identify the referring source and merchant web site 160, as represented as communication link 530. As with the previous embodiment, a second identifier uniquely identifying the particular user may be incorporated in the user's request. Affiliate manager web site 165, upon receiving amended request 530, redirects information requesting a connection between merchant web site 160 and the requesting user back to the user. This connection information includes a session identifier that enables merchant web site 160 to report to Affiliate manager 165 any transactions that occur during a user's visit. When this new connection information, as represented by link 550, is received by module HTTP In 200, module HTTP In 200 evaluates the response message and, in this case, determines that the response message includes the appropriate referral information. The response message, as represented by communication link 560, passes to web browser 125 for display to the user.

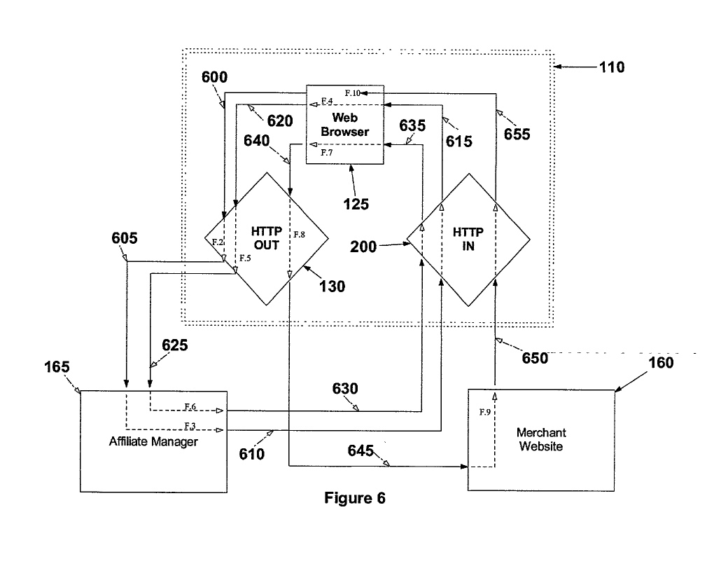

FIG. 6 illustrates an exemplary Internet transaction demonstrating a second embodiment of the invention. In this embodiment of the invention, the referring source identification code is dynamically incorporated into a request, as the request exists on user's computing system 110. The operation of this second embodiment of the invention is now disclosed using the transactional example of FIG. 5.

In this case, a user makes a direct request, as represented by communication link 600, to Merchant 2 site 160, which employs an independent third party affiliate manager 165. As it is necessary that the user be identified as a member of a group, organization, club, etc. that has an associative relation with the merchant site, the identification must be included in request, as represented by communication links 600 and 605. However, when the request is made, the request does not include the merchant address, but rather the address of affiliate manager 165. Hence, module HTTP Out 130 in evaluating the connection information does not amend the address as the address is not associated with a party that the user would receive benefit from being a member of a group, organization, club, etc. When the request is received at Affiliate Manager 165, as represented by communication links 610 and 615, a response is returned to user system 110, which contains the merchant information. A request, as represented by communication links 620 and 625, containing the merchant information is then issued from user system 110 to access Merchant 2 site 160. Prior to this second request exiting user system 110, module HTTP Out 130 evaluates the address to determine whether the address is indicative of a merchant from which the user would receive a benefit as the result of having a member of a designated group. In this case, as the address is indicative of a merchant that the user would receive a benefit from as a member of a group, module HTTP Out 130 dynamically amends the requested address to include the identification of the group, organization, club, etc. in a manner appropriate for the designated merchant. For example, if the user belongs to a group associated with Portal site 145, the identification code of Portal site 145 may be dynamically incorporated into the address. The amended address is then returned to Affiliate Manager 165 for recordation of the referral source. Affiliate manager 165 returns to the user system 110, via communication links 630 and 635, the information needed to establish a connection to the desired merchant, i.e., Merchant 2 site 160. The returned response now includes the designated merchant information and the referral source code.

A third request, as represented by communication link 640, is then issued and when evaluated by module HTTP Out 130, the re-issued request is determined to contain the merchant address and the appropriate identification code. The request is then directed to Merchant 2 site 160, as desired, as represented by communication link 645. Merchant 2 site 160 then responds to the received request, as represented by communication link 650 and 655. The requested merchant information is then displayed on browser 125.

While there have been shown and described and pointed out fundamental novel features of the present invention as applied to preferred embodiments thereof, it will be understood that various omissions, substitutions and changes in the methods described, may be made by those skilled in the art without departing from the spirit of the present invention. For example, it is expressly intended that all combinations of those method steps which perform substantially the same function in substantially the same way to achieve the same results are within the scope of the invention. Substitutions of elements from one described embodiment to another are also fully intended and contemplated.

1. A method of delivering an identifier associated with a referring source to an online retailer comprising the steps of:
receiving a response from said retailer prompted by a request to visit a web site maintained by said retailer;
examining said response to determine if said identifier is present in said response; and if said identifier is not present in said response, re-issuing said request to visit said web-site of said on-line retailer with said identifier added thereto.

2. The method of claim 1 further comprising the step of discarding said received response when said request is re-issued.

3. The method of claim 1 further comprising the step of selecting said identifier from a list of identifiers.

4. The method of claim 3 further comprising the step of selecting said identifier from a list of identifiers based upon said retailer from which said response was received.

5. The method of claim 4 wherein said request is not re-issued if said list does not contain an identifier associated with the retailer from which said response was received.

6. The method of claim 4 further comprising the step of passing said response to a browser or other software for display to a user when said re-quest is not re-issued.

7. The method of claim 3 wherein said list of identifiers includes identifiers associated with a plurality of known retailers.

8. The method of claim 1 wherein said request is not re-issued if said response contains said identifier associated with said retailer sending said response.

9. The method of claim 8 further comprising the step of passing said response to a browser or other software for display to a user when said re-quest is not re-issued

10. The method of claim 1 further comprising the step of adding a second identifier to said re-issued request identifying a specific user.

11. A method of delivering an identifier associated with a referring source to an on-line retailer comprising the steps of:
examining a request from a user to visit said retailer's web site; and
if said retailer is known, adding said identifier to said request and issuing said request.

12. The method of claim 11 wherein said identifier is selected from a list of identifiers, based upon said known retailer.

13. The method of claim 12 wherein said list of identifiers includes identifiers associated with a plurality of known retailers.

14. The method of claim 11 further comprising the step of adding a second identifier to said issued request identifying a specific user.

15. A system for delivering an identifier associated with a referring source to an on-line retailer comprising:
a list of known retailers and an associated list of identifiers for said referring source; and
software means for intercepting responses from the web sites of said on-line retailers, said software means being capable of determining if the proper identifier is present in the response and, if not, issuing a request to link to said web site, said request having an identifier selected from said list appended thereto.

16. The system of claim 15 wherein said software means selects said identifier from said list depending upon which on-line retailer sent said response.

17. The system of claim 15 wherein said software means adds a second identifier to said issued request which identifies a specific user

18. A system for delivering an identifier associated with a referring source to an on-line retailer comprising:
a list of known retailers and an associated list of identifiers for said referring source; and
software means for intercepting requests from a user to link to the web sites of one of said on-line retailers, said software means being capable of determining if the proper identifier is present in the request and, if not, issuing a modified request to link to said web site, said modified request having an identifier selected from said list appended thereto.

19. The system of claim 18 wherein said software means selects said identifier from said list depending upon which on-line retailer said user is attempting to link to.

20. The system of claim 19 wherein said software means adds a second identifier to said issued request which identifies a specific user.

21. A method of identifying a referring source to an on-line retailer comprising the steps of:
examining an Internet address for the presence of an identification code associated with said referring source, wherein said referring source is affiliated with each of said plurality of retailers;
selecting a referring source identification code from a plurality of known identification codes when said address is indicative of a retailer to which said referring source is affiliated; and
amending said Internet address to incorporate said selected identification code.

22. The method of claim 21 wherein the step of examining said Internet address occurs when receiving a response to a request to link to said Internet address.

23. The method of claim 22 further comprising the step of amending said Internet address to incorporate a second identification code to uniquely identify a user.

24. The method of claim 22 further comprising the step of re-issuing said request to link to said amended Internet address.

25. The method of claim 24 further comprising the step of discarding said response.

26. The method of claim 22 wherein said response is passed to a browser or other software for display to a user when said identification code is present in said Internet address.

27. The method of claim 21 wherein the step of examining said Internet address occurs prior to issuing said request

28. The method of claim 27 wherein a user enters said Internet address or selects said Internet address by clicking a hyperlink.

29. The method as recited in claim 27 where the step of amending said Internet address further includes the step of including said identification code in said Internet address in a manner required by each of said plurality of retailers.

30. The method of claim 27 further comprising the step of amending said Internet address to incorporate a second identification code to uniquely identify a user
